(19) United States
(12) Patent Application Publication
(10) Pub. No.: US 2026/0039550 A1
(43) Pub. Date: Feb. 5, 2026

(54) FRAME TRANSFER DEVICE, CONTROL METHOD, AND COMPUTER READABLE MEDIUM

(71) Applicant: Mitsubishi Electric Corporation, Tokyo (JP)

(72) Inventor: Yusuke SAKAGAMI, Tokyo (JP)

(73) Assignee: Mitsubishi Electric Corporation, Tokyo (JP)

(21) Appl. No.: 19/357,249

(22) Filed: Oct. 14, 2025

Related U.S. Application Data
(63) Continuation of application No. PCT/JP2024/013538, filed on Apr. 2, 2024.

(30) Foreign Application Priority Data
Jun. 5, 2023 (WO) PCT/JP2023/020851

(51) Int. Cl. H04L 41/0833; H04L 41/147

(52) U.S. Cl. CPC H04L 41/0833; H04L 41/147

(57) ABSTRACT

A frame transfer device (10) includes switches (20) that are a power saving switch (21) and a high performance switch (22), which consumes more power and is capable of higher performance than the power saving switch (21). A control unit (14) activates one of the switches (20) of the power saving switch (21) and the high performance switch (22) and deactivates the other one of the switches (20) depending on a network load. An allocation unit (12) allocates a received frame to the one of the switches (20) activated by the control unit (14).

### CROSS REFERENCE TO RELATED APPLICATIONS

This application is a Continuation of PCT International Application No. PCT/JP2024/013538, filed on Apr. 2, 2024, which claims priority under 35 U.S.C. § 119(a) to Patent Application No. PCT/JP2023/020851, filed in Japan on Jun. 5, 2023, all of which are hereby expressly incorporated by reference into the present application.

### TECHNICAL FIELD

The present disclosure relates to power saving in a frame transfer device.

### BACKGROUND ART

In the field of communication devices, communication speeds and transmission speeds are improving year by year, leading to an increase in power consumption. On the other hand, efforts are being made for power saving by miniaturing device processes or controlling power consumption of devices, for example. Each field is being called for to pursue power saving with the goal of achieving carbon neutrality, which is zero greenhouse gas emissions, by 2050.

In Patent Literature 1, it is described that a plurality of packet processing circuits each differing in processing performance are installed within a communication device, and an optimal processing circuit is selected and used for the amount of data input within a certain period of time. The plurality of packet processing circuits each differing in processing performance are a high-speed circuit, a medium-speed circuit, and a low-speed circuit, for example.

### CITATION LIST

### Patent Literature

Patent Literature 1: JP 2011-97319 A

### SUMMARY OF INVENTION

### Technical Problem

Normally, a processing circuit implemented in a device consumes a certain amount of power even when it is not processing data. Therefore, simply selecting and using a processing circuit that is optimal for the amount of data, as described in Patent Literature 1, is not sufficiently effective in reducing power consumption.

An object of the present disclosure is to make it possible to realize power saving in a frame transfer device.

### Solution to Problem

A frame transfer device according to the present disclosure includes:
switches that are a power saving switch and a high performance switch, the high performance switch consuming more power and being capable of higher performance than the power saving switch;
a control unit to activate one of the switches of the power saving switch and the high performance switch and deactivate the other one of the switches depending on a network load; and
an allocation unit to allocate a received frame to the one of the switches activated by the control unit.

### Advantageous Effects of Invention

In the present disclosure, one of switches is activated and the other one of the switches is deactivated depending on a network load. By deactivating the other one of the switches, it is possible to realize power saving in a frame transfer device as a whole.

### BRIEF DESCRIPTION OF DRAWINGS

FIG. 1 is a configuration diagram of a frame transfer device 10 according to Embodiment 1.

FIG. 2 is a diagram describing a configuration of an interface unit 11, an allocation unit 12, and a multiplexing unit 13 according to Embodiment 1.

FIG. 3 is a flowchart of a transfer process of the frame transfer device 10 according to Embodiment 1.

FIG. 4 is a flowchart of a switch control process according to Embodiment 1.

FIG. 5 is a flowchart of a process of switching a switch 20 in an active state from a power saving switch 21 to a high performance switch 22 according to Embodiment 1.

FIG. 6 is a diagram describing the process of switching the switch 20 in the active state from the power saving switch 21 to the high performance switch 22 according to Embodiment 1.

FIG. 7 is a flowchart of a process of switching the switch 20 in the active state from the high performance switch 22 to the power saving switch 21 according to Embodiment 1.

FIG. 8 is a diagram describing the process of switching the switch 20 in the active state from the high performance switch 22 to the power saving switch 21 according to Embodiment 1.

FIG. 9 is a state transition diagram of the switches 20 according to Embodiment 1.

FIG. 10 is a configuration diagram of the frame transfer device 10 according to Embodiment 2.

FIG. 11 is a state transition diagram of the switches 20 according to Embodiment 2.

FIG. 12 is a flowchart of a process of switching the switch 20 in the active state from the power saving switch 21 to the high performance switch 22 according to Embodiment 3.

FIG. 13 is a flowchart of a process of switching the switch 20 in the active state from the high performance switch 22 to the power saving switch 21 according to Embodiment 3.

### DESCRIPTION OF EMBODIMENTS

### Embodiment 1

### Description of Configuration

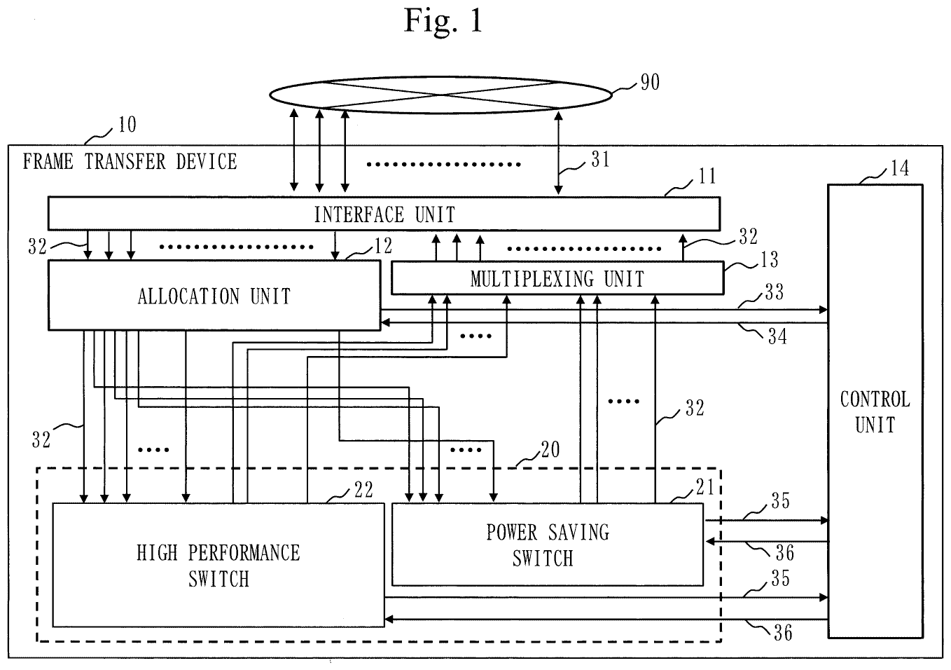

Referring to FIG. 1, a configuration of a frame transfer device 10 according to Embodiment 1 will be described.

The frame transfer device 10 is a computer that includes an interface unit 11, an allocation unit 12, a multiplexing unit 13, a control unit 14, and switches 20 that are a power saving switch 21 and a high performance switch 22.

The interface unit 11, the allocation unit 12, the multiplexing unit 13, and the control unit 14 are realized by an electronic circuit such as an LSI. LSI is an abbreviation for large-scale integration. At least part of the interface unit 11, the allocation unit 12, the multiplexing unit 13, and the control unit 14 may be realized by software. Each of the power saving switch 21 and the high performance switch 22 is realized by an electronic circuit such as an LSI. Alternatively, each of the power saving switch 21 and the high performance switch 22 may be a device that can operate independently.

Each of the switches 20 has a function of transferring communication frames sequentially according to a predetermined rule or priority order. Each of the switches 20 requires a frame buffer to perform sequence control. If the capacity of the frame buffer is large, the frame buffer can withstand processing to receive many communication frames for a long time. That is, if the capacity of the frame buffer is large, this means high performance. On the other hand, if the capacity of the frame buffer is large, the power consumed by the frame buffer increases, and the power consumption required to control the frame buffer also increases. That is, if the capacity of the frame buffer is large, the power consumption also increases.

The high performance switch 22 is the switch 20 that consumes more power and is capable of higher performance than the power saving switch 21.

The interface unit 11 is a network interface between the frame transfer device 10 and an external network 90. That is, the frame transfer device 10 is connected to the external network 90 through the interface unit 11. There are various standards and communication media for network interfaces, but any type may be adopted here.

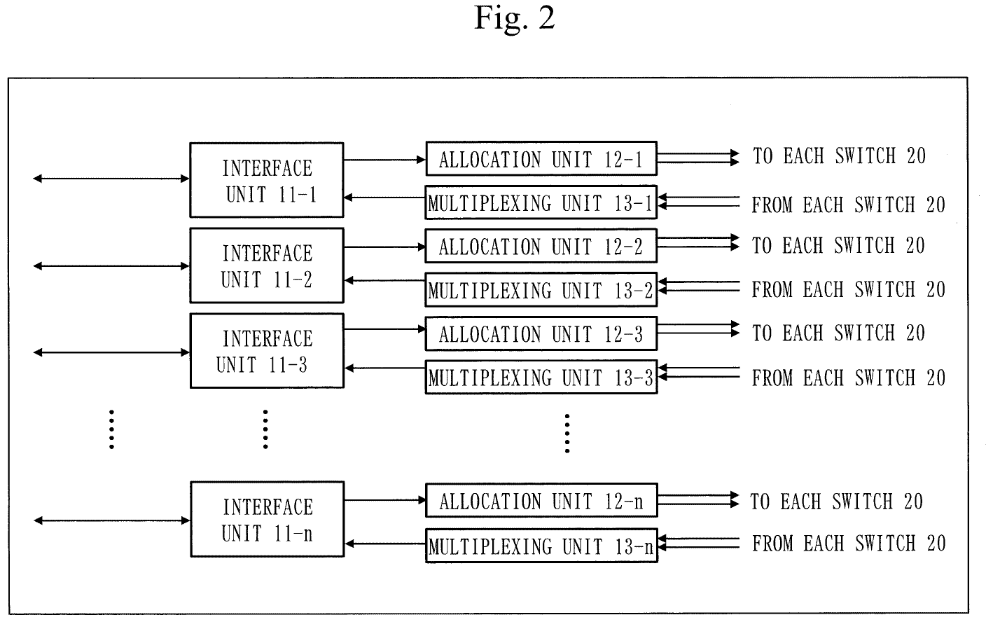

Referring to FIG. 2, a configuration of the interface unit 11, the allocation unit 12, and the multiplexing unit 13 according to Embodiment 1 will be described.

The interface unit 11, the allocation unit 12, and the multiplexing unit 13 are provided corresponding to each of a plurality of networks 90. In FIG. 2, it is assumed that there are n networks 90, a network 90-1 to a network 90-n. The interface unit 11, the allocation unit 12, and the multiplexing unit 13 are provided corresponding to each of the networks 90, the network 90-1 to the network 90-n.

A frame received from the network 90 is processed by the corresponding interface unit 11, allocation unit 12, and multiplexing unit 13. For example, a frame received from the network 90-1 is processed by an interface unit 11-1, an allocation unit 12-1, and a multiplexing unit 13-1.

### Description of Operation

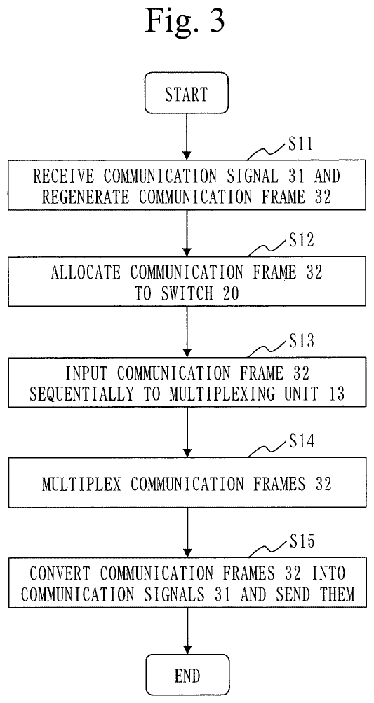

Referring to FIGS. 3 to 9, the operation of the frame transfer device 10 according to Embodiment 1 will be described.

A procedure for the operation of the frame transfer device 10 according to Embodiment 1 is equivalent to a control method of the frame transfer device 10 according to Embodiment 1. A program that realizes the operation of the frame transfer device 10 according to Embodiment 1 is equivalent to a control program of the frame transfer device 10 according to Embodiment 1.

The operation of the frame transfer device 10 according to Embodiment 1 includes a transfer process and a switch control process. The transfer process and the switch control process are executed in parallel.

Referring to FIG. 3, the transfer process of the frame transfer device 10 according to Embodiment 1 will be described.

### (Step S11: Reception Process)

The interface unit 11 receives a communication signal 31, such as an electrical signal or optical signal for communication, from the network 90. The interface unit 11 regenerates a communication frame 32 from the communication signal 31 and inputs the communication frame 32 to the allocation unit 12. The interface unit 11 has a function of regenerating the communication frame 32 from the communication signal 31 for each network 90.

### (Step S12: Allocation Process)

The allocation unit 12 allocates and inputs the communication frame 32 to the power saving switch 21 or the high performance switch 22 according to allocation instruction information 34 transmitted from the control unit 14 in the switch control process.

### (Step S13: Switch Process)

The power saving switch 21 or the high performance switch 22 inputs the communication frame 32 to the multiplexing unit 13 in an order according to a predetermined rule or priority. As a result, the communication frame 32 is transferred in the order according to the predetermined rule or priority.

### (Step S14: Multiplexing Process)

The multiplexing unit 13 performs multiplexing in order to avoid a collision of communication frames 32 output by the power saving switch 21 or the high performance switch 22 toward the interface unit 11 corresponding to the same network 90. As a result, the multiplexing unit 13 combines the communication frames 32 into one according to the input order, and then inputs them to the interface unit 11.

### (Step S15: Transfer Process)

The interface unit 11 converts the communication frames 32 input by the multiplexing unit 13 into the communication signals 31, and then outputs them to the network 90.

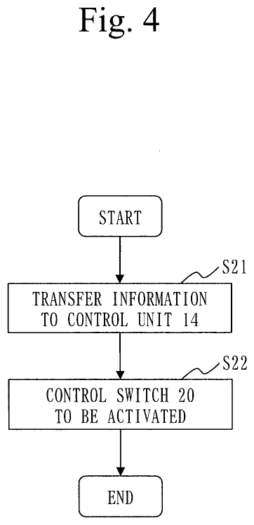

Referring to FIG. 4, the switch control process according to Embodiment 1 will be described.

### (Step S21: Information Transmission Process)

The allocation unit 12 periodically determines a flow rate per unit time of communication frames 32 input from the interface unit 11. Then, the allocation unit 12 transmits traffic status information 33 indicating the determined flow rate to the control unit 14.

The power saving switch 21 and the high performance switch 22 each transmit statistical information, such as internal traffic counter information, the number of transfers, and the number of discards, a frame buffer status, MAC learning result information, and so on to the control unit 14 as internal switch information 35. MAC is an abbreviation for media access control. The control unit 14 may acquire the internal switch information 35. As a method for transmitting the internal switch information 35, a method that conforms to the functions of the switch 20 is used. For example, as the method for transmitting the internal switch information 35, an interrupt process from the switch 20 or a polling process by the control unit 14 may be used.

### (Step S22: Control Process)

The control unit 14 activates one of the switches 20 of the power saving switch 21 and the high performance switch 22 and deactivates the other one of the switches 20 depending on the network load. At this time, the control unit 14 uses the traffic status information 33 and the internal switch information 35 to determine which one of the switches 20 of the power saving switch 21 and the high performance switch 22 is to be activated. Then, the control unit 14 sends control signals 36 to the power saving switch 21 and the high performance switch 22 to activate one of the switches 20 and deactivate the other one of the switches 20. Furthermore, the control unit 14 transfers, to the allocation unit 12, the allocation instruction information 34 indicating the switch 20 in an active state as an input destination.

When the frame transfer device 10 is started up, the control unit 14 activates the power saving switch 21 and deactivates the high performance switch 22 as an initial state in order to maximize the power saving effect.

The power saving switch 21 and the high performance switch 22 each transition between an active state and an inactive state under the control of the control unit 14. The control is performed so that communication frames 32 from the allocation unit 12 are input to the switch 20 in the active state, and communication frames 32 from the allocation unit 12 are not input to the switch 20 in the inactive state.

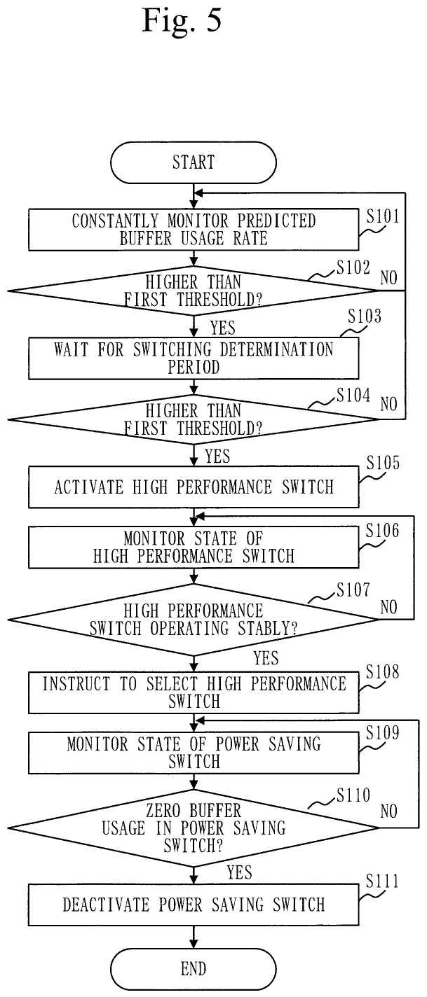

Referring to FIGS. 5 to 8, the control process according to Embodiment 1 (step S22 in FIG. 4) will be described.

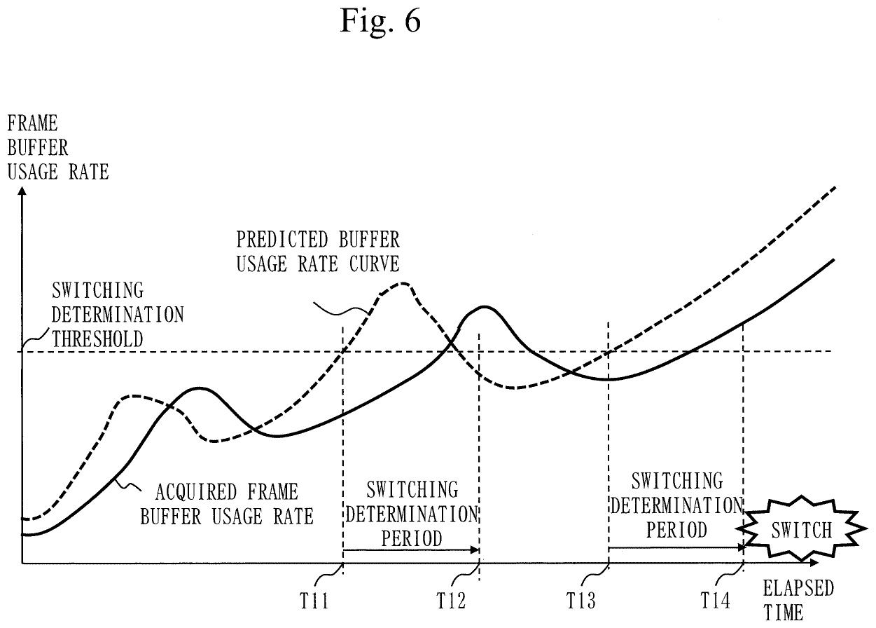

Referring to FIGS. 5 and 6, a process of switching the switch 20 in the active state from the power saving switch 21 to the high performance switch 22 will be described.

### (Step S101: Load Monitoring Process)

The control unit 14 monitors the network load. The control unit 14 calculates a predicted load, which is the network load after a reference time period, and compares the predicted load with a first threshold.

Specifically, the control unit 14 calculates a predicted frame buffer usage rate of the power saving switch 21 as the predicted load. The control unit 14 calculates an increase/decrease curve of the frame buffer usage rate using the traffic status information 33 and the internal switch information 35 that is transmitted from the power saving switch 21. The control unit 14 determines the predicted usage rate after the reference time period based on the increase/decrease curve. Then, the control unit 14 compares the predicted usage rate with the first threshold.

For example, the control unit 14 predicts a frame buffer usage rate at each time point based on the most recent frame buffer usage status indicated by the internal switch information 35 and an expected input traffic volume at each future time point. This determines the increase/decrease curve of the frame buffer usage rate. The control unit 14 predicts the expected input traffic volume at each time point based on the traffic status information 33 in the past. The control unit 14 predicts the expected input traffic volume at each time point by learning changes in the flow volume indicated by the traffic status information 33 in the past. Consequently, as the operation period becomes longer and learning progresses, the accuracy of traffic volume prediction increases. As a result, the increase/decrease curve of the frame buffer usage rate is also accurately predicted.

### (Step S102: First Determination Process)

The control unit 14 determines whether the predicted usage rate is higher than the first threshold.

If the predicted usage rate is higher than the first threshold, the control unit 14 advances the process to step S103. If the predicted usage rate is not higher than the first threshold, the control unit 14 returns the process to step S101.

### (Step S103: Waiting Process)

The control unit 14 waits until a switching determination period elapses from a first checking time point at which the determination in step S102 is made. The switching determination period is set in advance.

### (Step S104: Second Determination Process)

The control unit 14 determines whether the predicted usage rate is higher than the first threshold.

If the predicted usage rate is higher than the first threshold, the control unit 14 advances the process to step S105. If the predicted usage rate is not higher than the first threshold, the control unit 14 returns the process to step S101.

### (Step S105: Activation Process)

The control unit 14 sends the control signal 36 to activate the high performance switch 22. The activation may be a cold boot or a warm boot. A cold boot is to power and then start the high performance switch 22. A warm boot is to release the high performance switch 22 from a stop state. The stop state is one of a sleep state and a suspended state.

The control unit 14 sets, in the high performance switch 22, information required for transferring communication frames 32, such as a MAC learning result updated by the power saving switch 21 while the high performance switch 22 is in the inactive state. The MAC learning result is information included in the internal switch information 35. This causes the state of the high performance switch 22 to be synchronized with the state of the power saving switch 21.

### (Step S106: State Monitoring Process)

The control unit 14 monitors the state of the high performance switch 22. For example, information on the state of the high performance switch 22 is acquired by the interrupt process from the high performance switch 22 or the polling process by the control unit 14.

### (Step S107: State Determination Process)

The control unit 14 determines whether the high performance switch 22 has completed a transition from the inactive state to the active state.

If the transition has been completed and stable operation has been achieved, the control unit 14 advances the process to step S108. If the transition has not been completed and stable operation has not been achieved, the control unit 14 returns the process to step S106.

### (Step S108: Allocation Instruction Process)

The control unit 14 transmits, to the allocation unit 12, the allocation instruction information 34 indicating the high performance switch 22 as the input destination. That is, when the high performance switch 22 has completed the transition to the active state and achieved stable operation, the control unit 14 instructs the allocation unit 12 to set the high performance switch 22 as the input destination. In other words, the control unit 14 maintains the state in which the power saving switch 21 is the input destination until the high performance switch 22 completes the transition to the active state and achieves stable operation.

### (Step S109: Usage Monitoring Process)

The control unit 14 monitors the frame buffer usage status included in the internal switch information 35 transmitted from the power saving switch 21.

### (Step S110: Usage Determination Process)

The control unit 14 determines whether the frame buffer usage rate of the power saving switch 21 has become zero. If the frame buffer usage rate has become zero, this means that there is no longer any frame being output from the power saving switch 21.

If the frame buffer usage rate has become zero, the control unit 14 advances the process to step S111. If the frame buffer usage rate has not become zero, the control unit 14 returns the process to step S109.

### (Step S111: Deactivation Process)

The control unit 14 sends the control signal 36 to deactivate the power saving switch 21. If the activation is a cold boot in step S205 to be described later, the deactivation is to shut down the power saving switch 21 and then cut off the power supply. If the activation is a warm boot in step S205 to be described later, the deactivation is to set the power saving switch 21 to the stop state.

In steps S101 to S104, the control unit 14 determines whether the predicted load at the first checking time point is higher than the first threshold, and whether the predicted load at a second checking time point, which is the switching determination period later than the first checking time point, is higher than the first threshold.

At time T11 in FIG. 6, the predicted load is higher than the first threshold. However, at time T12, which is the switching determination period later than time T11, the predicted load is lower than the first threshold. Therefore, in this case, the control unit 14 does not decide to activate the high performance switch 22, and maintains the power saving switch 21 in the active state.

At time T13 in FIG. 6, the predicted load is higher than the first threshold. Moreover, at time T14, which is the switching determination period later than time T13, the predicted load is also higher than the first threshold. Therefore, in this case, at time T14 the control unit 14 decides to activate the high performance switch 22.

The first threshold is determined based on the configuration of the network to which it is applied, information on generally expected traffic fluctuations such as busy time periods, statistical information on traffic fluctuations learned by the frame transfer device 10, and so on. The first threshold is set in advance, or an optimal value is automatically reflected based on learning results. It is assumed that the first threshold is set to a value based on the assumption that the power saving switch 21 is selected during a time period from the activation process of the high performance switch 22 until a transition to stable operation.

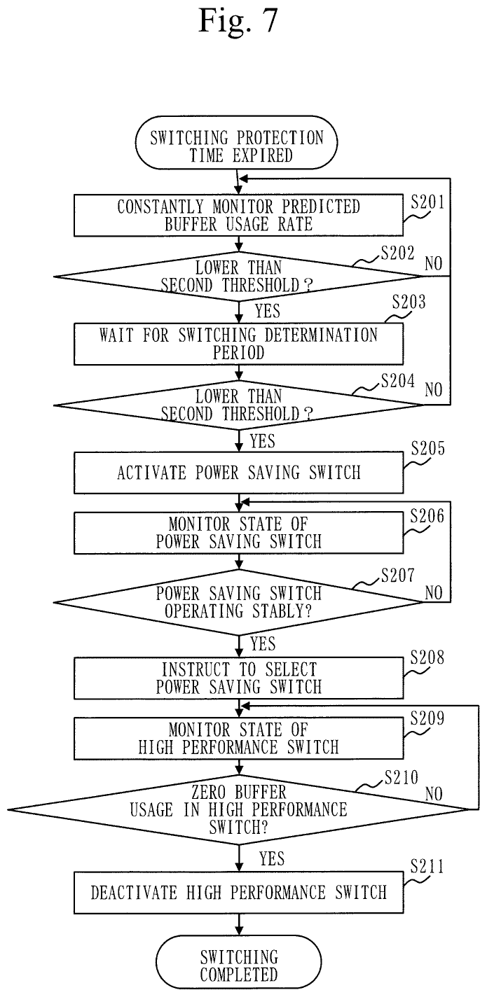

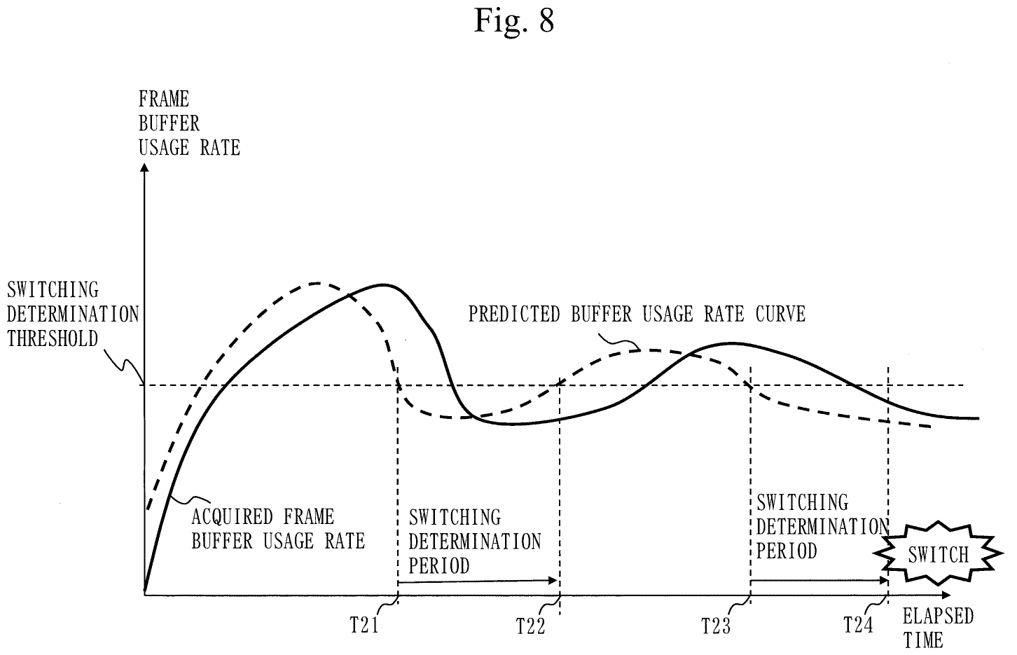

Referring to FIGS. 7 and 8, a process of switching the switch 20 in the active state from the high performance switch 22 to the power saving switch 21 will be described.

### (Step S201: Load Monitoring Process)

The control unit 14 monitors the network load. The control unit 14 calculates a predicted load, which is the network load after the reference time period, and compares the predicted load with a second threshold.

Specifically, the control unit 14 calculates a predicted frame buffer usage rate of the high performance switch 22 as the predicted load. The control unit 14 calculates an increase/decrease curve of the frame buffer usage rate using the traffic status information 33 and the internal switch information 35 that is transmitted from the high performance switch 22. The control unit 14 determines a predicted usage rate after the reference time period based on the increase/decrease curve. Then, the control unit 14 compares the predicted usage rate with the second threshold.

### (Step S202: First Determination Process)

The control unit 14 determines whether the predicted usage rate is lower than the second threshold.

If the predicted usage rate is lower than the second threshold, the control unit 14 advances the process to step S203. If the predicted usage rate is not lower than the second threshold, the control unit 14 returns the process to step S201.

### (Step S203: Waiting Process)

The control unit 14 waits until the switching determination period elapses from the first checking time point at which the determination in step S202 is made.

### (Step S204: Second Determination Process)

The control unit 14 determines whether the predicted usage rate is lower than the second threshold.

If the predicted usage rate is lower than the second threshold, the control unit 14 advances the process to step S205. If the predicted usage rate is not lower than the second threshold, the control unit 14 returns the process to step S201.

### (Step S205: Activation Process)

The control unit 14 sends the control signal 36 to activate the power saving switch 21. The activation may be a cold boot or a warm boot. A cold boot is to power and then start the power saving switch 21. A warm boot is to release the power saving switch 21 from the stop state.

The control unit 14 sets, in the high performance switch 22, information required for transferring communication frames 32, such as a MAC learning result updated by the high performance switch 22 while the power saving switch 21 is in the inactive state. This causes the state of the power saving switch 21 to be synchronized with the state of the high performance switch 22.

### (Step S206: State Monitoring Process)

The control unit 14 monitors the state of the power saving switch 21. For example, information on the state of the power saving switch 21 is acquired by the interrupt process from the power saving switch 21 or the polling process by the control unit 14.

### (Step S207: State Determination Process)

The control unit 14 determines whether the power saving switch 21 has completed a transition from the inactive state to the active state.

If the transition has been completed and stable operation has been achieved, the control unit 14 advances the process to step S208. If the transition has not been completed and stable operation has not been achieved, the control unit 14 returns the process to step S206.

### (Step S208: Allocation Instruction Process)

The control unit 14 transmits, to the allocation unit 12, the allocation instruction information 34 indicating the power saving switch 21 as the input destination. That is, when the power saving switch 21 has completed the transition to the active state and achieved stable operation, the control unit 14 instructs the allocation unit 12 to set the power saving switch 21 as the input destination. In other words, the control unit 14 maintains the state in which the high performance switch 22 is the input destination until the power saving switch 21 completes the transition to the active state and achieves stable operation.

### (Step S209: Usage Monitoring Process)

The control unit 14 monitors the frame buffer usage status included in the internal switch information 35 transmitted from the high performance switch 22.

### (Step S210: Usage Determination Process)

The control unit 14 determines whether the frame buffer usage rate of the high performance switch 22 has become zero. If the frame buffer usage rate has become zero, this means that there is no longer any frame being output from the high performance switch 22.

If the frame buffer usage rate has become zero, the control unit 14 advances the process to step S211. If the frame buffer usage rate has not become zero, the control unit 14 returns the process to step S209.

### (Step S211: Deactivation Process)

The control unit 14 sends the control signal 36 to deactivate the high performance switch 22. If the activation is a cold boot in step S105 described above, the deactivation is to shut down the high performance switch 22 and then cut off the power supply. If the activation is a warm boot in step S105 described above, the deactivation is to set the high performance switch 22 to the stop state.

In steps S201 to S204, the control unit 14 determines whether the predicted load at the first checking time point is lower than the second threshold, and whether the predicted load at the second checking time point, which is the switching determination period later than the first checking time point, is lower than the second threshold.

At time T21 in FIG. 8, the predicted load is lower than the second threshold. However, at time T22, which is the switching determination period later than time T21, the predicted load is higher than the second threshold. Therefore, in this case, the control unit 14 does not decide to activate the power saving switch 21, and maintains the high performance switch 22 in the active state.

At time T23 in FIG. 8, the predicted load is lower than the second threshold. Moreover, at time T24, which is the switching determination period later than time T23, the predicted load is also lower than the second threshold. Therefore, in this case, at time T24 the control unit 14 decides to activate the power saving switch 21.

The second threshold is determined based on the configuration of the network to which it is applied, information on generally expected traffic fluctuations such as busy time periods, statistical information on traffic fluctuations learned by the frame transfer device 10, and so on. The second threshold is set in advance, or an optimal value is automatically reflected based on learning results. The second threshold is set with allowance in consideration of the frame buffer size of the power saving switch 21 so that the switch 20 to be activated is not switched repeatedly at short intervals.

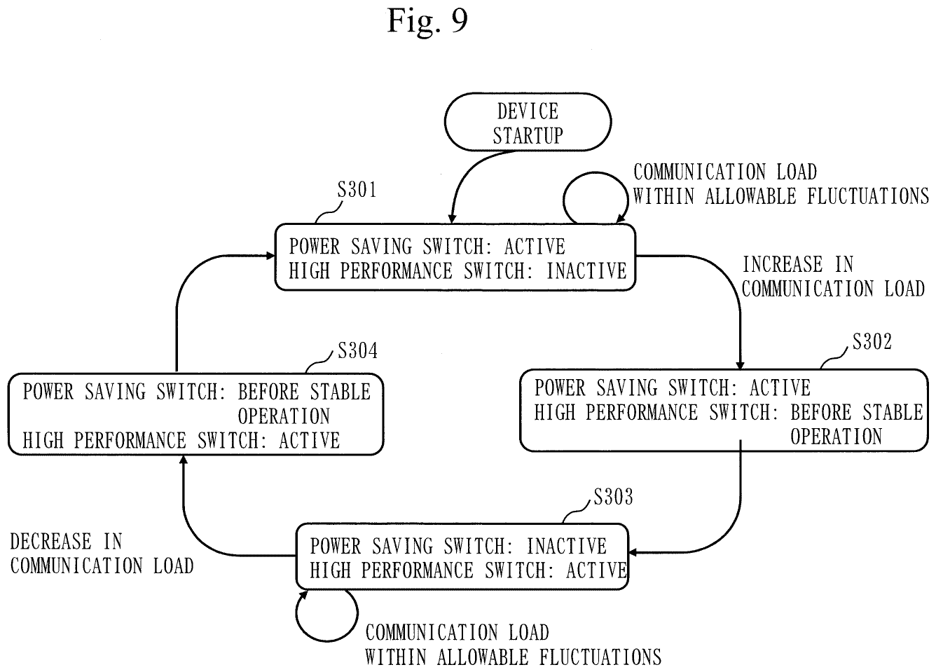

Referring to FIG. 9, the state transitions of the switches 20 according to Embodiment 1 will be described.

The frame transfer device 10 starts up. Then, the power saving switch 21 is maintained in the active state (S301), and when it is determined that the performance of the power saving switch 21 cannot handle processing due to an increase in the communication load, the high performance switch 22 is activated (S302). After waiting for stable operation of the high performance switch 22, the power saving switch 21 is deactivated, and only the high performance switch 22 is maintained in the active state (S303). When the communication load decreases and it is determined that the performance of the power saving switch 21 can handle processing, the power saving switch 21 is activated (S304). After waiting for stable operation of the power saving switch 21, the high performance switch 22 is deactivated, and only the power saving switch 21 is maintained in the active state (S301).

When frames are multiplexed, there may be a case where the input amount of an input side, which is a frame multiplexing target, transiently or steadily exceeds the output amount of an output side, which is a frame multiplexing result.

In Embodiment 1, in a transitional state in which the switches 20 are being switched in the switch control process, frames are input to the multiplexing unit 13 from both the high performance switch 22 and the power-saving switch 20. During a period in which the transitional state continues, there is a possibility that the input amount may exceed the output amount in the multiplexing unit 13. Specifically, the transitional state occurs during the following periods (1) and (2). The period (1) is a period from when the high performance switch 22 is selected as the input destination in step S108 of FIG. 5 until the frame buffer usage rate of the power saving switch 21 becomes zero in step S110. The period (2) is a period from when the power saving switch 21 is selected as the input destination in step S208 of FIG. 7 until the frame buffer usage rate of the high performance switch 22 becomes zero in step S210.

In Embodiment 1, the multiplexing unit 13 has the frame buffer. The multiplexing unit 13 temporarily stores communication frames 32 output from the power saving switch 21 and the high performance switch 22 in the frame buffer, and sequentially multiplexes the frames and inputs them to the interface unit 11. This makes it possible to multiplex the communication frames 32 without any loss even in a case where the input amount exceeds the output amount.

### Effects of Embodiment 1

As described above, the frame transfer device 10 according to Embodiment 1 activates one of the switches 20 and deactivates the other one of the switches 20 depending on the network load. This makes it possible to realize power saving in the frame transfer device 10 as a whole.

The frame transfer device 10 according to Embodiment 1 performs comparison with a threshold not only at the first checking time point but also at the second checking time point, which is the switching determination period later than the first checking time point, so as to determine whether or not to switch the switch 20 to be activated. This prevents the switch 20 to be activated from being repeatedly switched in a short period of time. As a result, power consumption associated with switching can be reduced.

### Embodiment 2

Embodiment 2 differs from Embodiment 1 in that there are three types of switches 20. In Embodiment 2, this difference will be described and description of the same aspects will be omitted.

In Embodiment 1, the frame transfer device 10 includes the switches 20 of two types of performance, the power saving switch 21 and the high performance switch 22. However, the frame transfer device 10 may include the switches 20 of three or more types of performance.

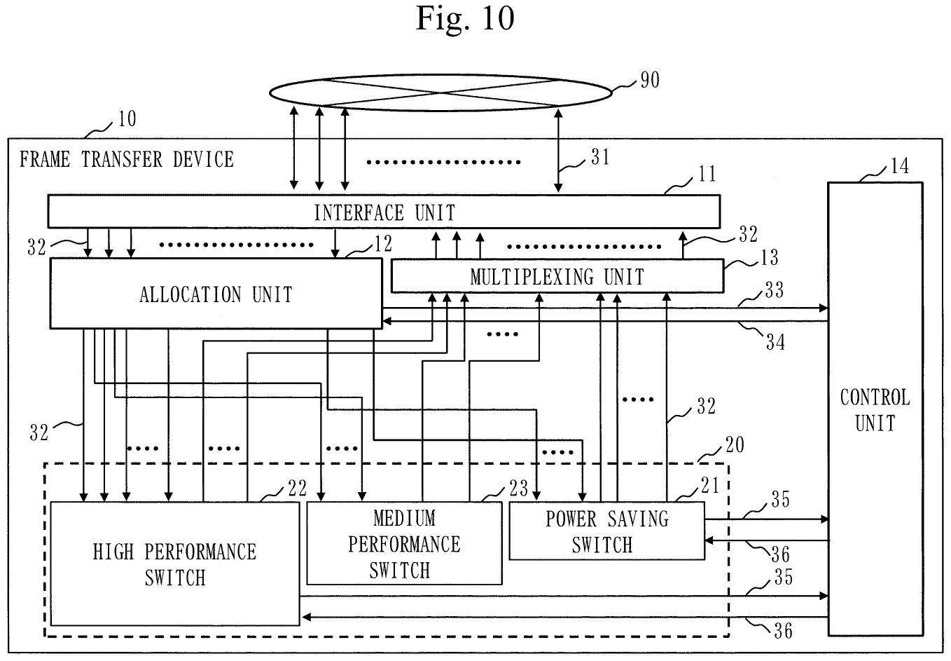

For example, as illustrated in FIG. 10, the frame transfer device 10 may include a medium performance switch 23 in addition to the power saving switch 21 and the high performance switch 22 as the switches 20. The medium performance switch 23 is the switch 20 that consumes more power and is capable of higher performance than the power saving switch 21, and consumes less power and is capable of lower performance than the high performance switch 22.

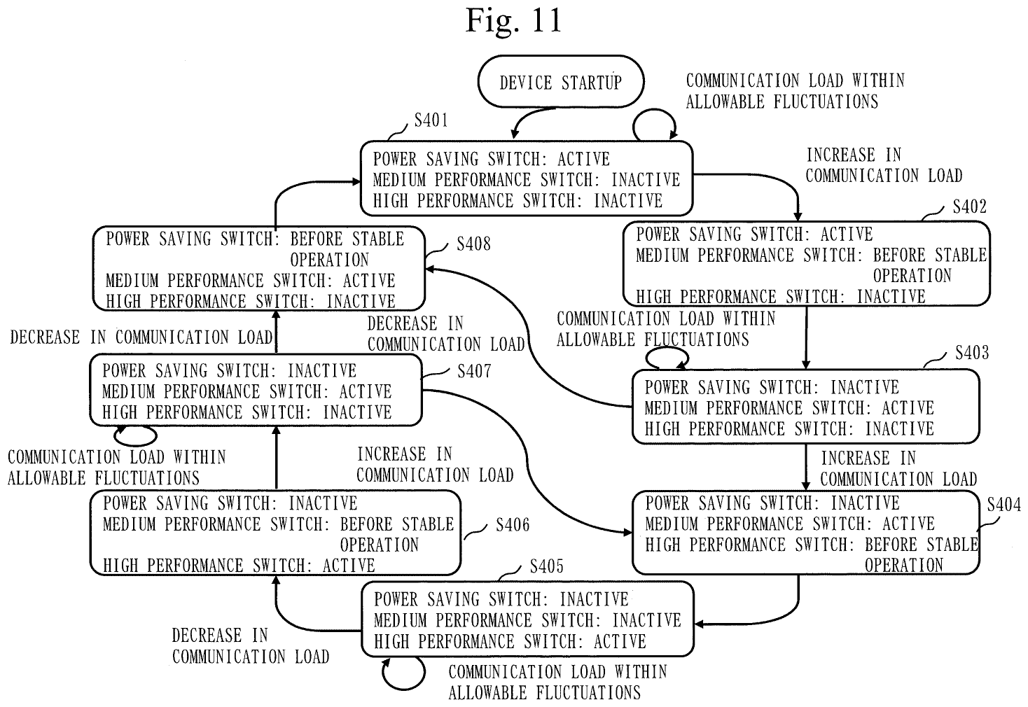

Referring to FIG. 11, the state transitions of the switches 20 according to Embodiment 2 will be described.

The frame transfer device 10 starts up. Then, the power saving switch 21 is maintained in the active state (S401), and when it is determined that the performance of the power saving switch 21 cannot handle processing due to an increase in the communication load, the medium performance switch 23 is activated first (S402). After waiting for stable operation of the medium performance switch 23, the power saving switch 21 is deactivated, and only the medium performance switch 23 is maintained in the active state (S403). When the communication load further increases and it is determined that the performance of the medium performance switch 23 cannot handle processing, the high performance switch 22 is activated (S404). After waiting for stable operation of the high performance switch 22, the medium performance switch 23 is deactivated, and only the high performance switch 22 is maintained in the active state (S405).

When the communication load decreases from the state of S403 and it is determined that the performance of the power saving switch 21 can handle processing, the power saving switch 21 is activated (S408). After waiting for stable operation of the power saving switch 21, the medium performance switch 23 is deactivated, and only the power saving switch 21 is maintained in the active state (S401).

When the communication load decreases from the state of S405 and it is determined that the performance of the medium performance switch 23 can handle processing, the medium performance switch 23 is activated (S406). After waiting for stable operation of the medium performance switch 23, the high performance switch 22 is deactivated, and only the medium performance switch 23 is maintained in the active state (S407). Like the state of S403, the state of S407 transitions to S404 when the communication load increases, and transitions to S401 when the communication load decreases.

### Effects of Embodiment 2

As described above, the frame transfer device 10 according to Embodiment 2 includes the switches 20 of three or more types. Also in this case, one of the switches 20 is set to the active state while the other switches 20 are set to the inactive state depending on the network load. This makes it possible to realize power saving in the frame transfer device 10 as a whole.

### Embodiment 3

Embodiment 3 differs from Embodiments 1 and 2 in that the multiplexing unit 13 does not have a frame buffer for multiplexing frames. In Embodiment 3, this difference will be described, and description of the same aspects will be omitted.

In Embodiment 3, a case where changes are made to Embodiment 1 will be described. However, it is also possible to make changes to Embodiment 2.

In Embodiment 3, the frame buffer of the multiplexing unit 13 is omitted, the switches 20 are switched in a procedure that prevents frames from being lost when frames are multiplexed in the switch control process.

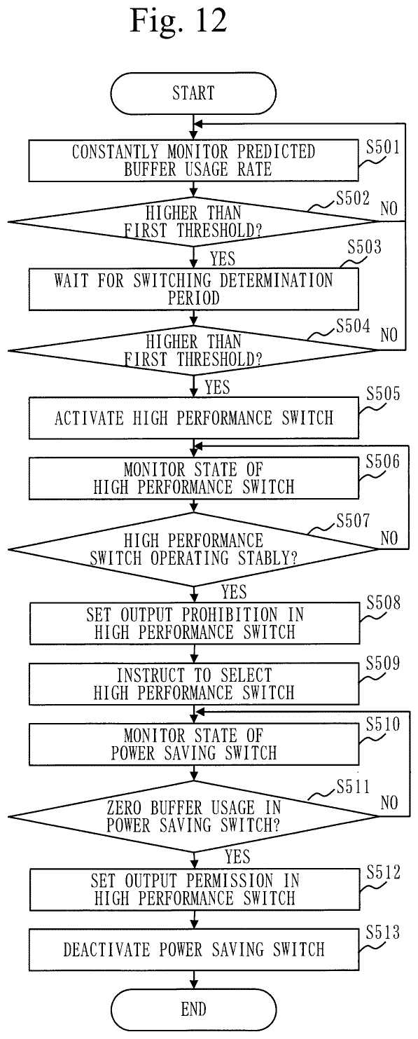

Referring to FIG. 12, a process of switching the switch 20 in the active state from the power saving switch 21 to the high performance switch 22 according to Embodiment 3 will be described. The processes of steps S501 to S507 are the same as the processes of steps S101 to S107 in FIG. 5.

### (Step S508: Output Prohibition Setting Process)

After the high performance switch 22 has achieved stable operation, that is, has completed startup and is ready to receive various settings, the control unit 14 performs an operation to temporarily stop the output function of the high performance switch 22. The control unit 14 blocks an output port of the high performance switch 22 here.

As a result, when the high performance switch 22 receives communication frames 32 from the allocation unit 12, the frames are stored in the frame buffer of the high performance switch 22 instead of being transmitted to the multiplexing unit 13.

The processes of steps S509 to S511 are the same as the processes of steps S108 to S110 in FIG. 5.

### (Step S512: Output Permission Setting Process)

After the buffer usage rate of the power saving switch 21 becomes zero, that is, after a transition is made to a state where there is no longer any frame being output from the power saving switch 21, the control unit 14 releases the output prohibition setting that has been temporarily set for the high performance switch 22. The control unit 14 opens the output port of the high performance switch 22 here.

As a result, the high performance switch 22 starts outputting the frames stored in the frame buffer to the multiplexing unit 13.

The process of step S513 is the same as the process of step S111 in FIG. 5.

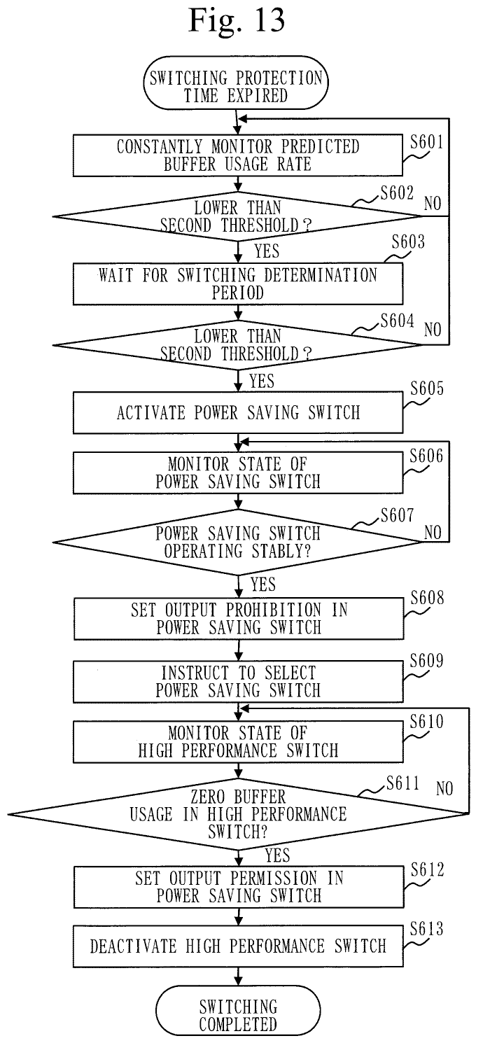

Referring to FIG. 13, a process of switching the switch 20 in the active state from the high performance switch 22 to the power saving switch 21 according to Embodiment 3 will be described. The processes of steps S601 to S607 are the same as the processes of steps S201 to S207 in FIG. 7.

### (Step S608: Output Prohibition Setting Process)

After the power saving switch 21 has achieved stable operation, that is, has completed startup and is ready to receive various settings, the control unit 14 performs an operation to temporarily stop the output function of the power saving switch 21. The control unit 14 blocks an output port of the power saving switch 21 here.

As a result, when the power saving switch 21 receives communication frames 32 from the allocation unit 12, the frames are stored in the frame buffer of the power saving switch 21 instead of being transmitted to the multiplexing unit 13.

The processes of steps S609 to S611 are the same as the processes of steps S208 to S210 in FIG. 7.

### (Step S612: Output Permission Setting Process)

After the buffer usage rate of the high performance switch 22 becomes zero, that is, after a transition is made to a state where there is no longer any frame being output from the high performance switch 22, the control unit 14 releases the output prohibition setting that has been temporarily set for the power saving switch 21. The control unit 14 opens the output port of the power saving switch 21 here.

As a result, the power saving switch 21 starts outputting the frames stored in the frame buffer to the multiplexing unit 13.

The process of step S613 is the same as the process of step S211 in FIG. 7.

### Effects of Embodiment 3

As described above, in the frame transfer device 10 according to Embodiment 3, the communication frames 32 from the power saving switch 21 and the high performance switch 22 are never simultaneously input to the multiplexing unit 13. Therefore, the maximum input speed never exceeds the output speed, eliminating the need for a frame buffer for multiplexing the communication frames 32. As a result, it is possible to realize reduction in the functionality, size, and power consumption of the multiplexing unit 13 and consequently in those of the frame transfer device 10.

“Unit” in the above description may be interpreted as “circuit”, “step”, “procedure”, “process”, or “processing circuitry”.

The embodiments and variations of the present disclosure have been described above. Two or more of these embodiments and variations may be implemented in combination. Alternatively, one or more of them may be partially implemented. The present disclosure is not limited to the above embodiments and variations, and various modifications can be made as necessary.

### REFERENCE SIGNS LIST

10: frame transfer device; 11: interface unit; 12: allocation unit; 13: multiplexing unit; 14: control unit; 20: switch; 21: power saving switch; 22: high performance switch; 23: medium performance switch; 31: communication signal; 32: communication frame; 33: traffic status information; 34: allocation instruction information; 35: internal switch information; 36: control signal; 90: network.

1. A frame transfer device comprising:
switches that are a power saving switch and a high performance switch, the high performance switch consuming more power and being capable of higher performance than the power saving switch; and
processing circuitry to:
activate one of the switches of the power saving switch and the high performance switch and deactivate the other one of the switches depending on a network load, and
allocate a received frame to the one of the switches that has been activated,
wherein the processing circuitry calculates a predicted load, which is a network load after a reference time period, and compares the predicted load with a threshold to determine which one of the switches of the power saving switch and the high performance switch is to be activated, and when the power saving switch has been activated, the processing circuitry activates the high performance switch and deactivates the power saving switch when the predicted load exceeds a first threshold.

2. A frame transfer device comprising:
switches that are a power saving switch and a high performance switch, the high performance switch consuming more power and being capable of higher performance than the power saving switch; and
processing circuitry to:
activate one of the switches of the power saving switch and the high performance switch and deactivate the other one of the switches depending on a network load, and
allocate a received frame to the one of the switches that has been activated,
wherein the processing circuitry calculates a predicted load, which is a network load after a reference time period, and compares the predicted load with a threshold to determine which one of the switches of the power saving switch and the high performance switch is to be activated, and when the high performance switch has been activated, the processing circuitry activates the power saving switch and deactivates the high performance switch when the predicted load becomes lower than a second threshold.

3. A frame transfer device comprising:
switches that are a power saving switch and a high performance switch, the high performance switch consuming more power and being capable of higher performance than the power saving switch; and
processing circuitry to:
activate one of the switches of the power saving switch and the high performance switch and deactivate the other one of the switches depending on a network load,
allocate a received frame to the one of the switches that has been activated, and
multiplex frames output from each of the switches,
wherein after activating the one of the switches, the processing circuitry permits a frame to be output from the one of the switches when there is no longer any frame being output from the other one of the switches.

4. The frame transfer device according to claim 3,
wherein the processing circuitry calculates a predicted load, which is a network load after a reference time period, and compares the predicted load with a threshold to determine which one of the switches of the power saving switch and the high performance switch is to be activated.

5. The frame transfer device according to claim 1,
wherein when the predicted load is higher than the first threshold at a first checking time point and the predicted load is higher than the first threshold at a second checking time point, which is a switching determination period later than the first checking time point, the processing circuitry activates the high performance switch and deactivates the power saving switch.

6. The frame transfer device according to claim 2,
wherein when the predicted load is lower than the second threshold at a first checking time point and the predicted load is lower than the second threshold at a second checking time point, which is a switching determination period later than the first checking time point, the processing circuitry activates the power saving switch and deactivates the high performance switch.

7. The frame transfer device according to claim 1,
wherein after the one of the switches has been activated, the processing circuitry deactivates the other one of the switches.

8. The frame transfer device according to claim 1,
wherein to deactivate a switch is to shut down the switch and then shut down a power supply, and
wherein to activate a switch is to supply power to the switch and then start up the switch.

9. The frame transfer device according to claim 1,
wherein to deactivate a switch is to set the switch to a stop state, which is one of a sleep state and a suspended state, and
wherein to activate a switch is to release the switch from the stop state.

10. The frame transfer device according to claim 1,
wherein the processing circuitry multiplexes frames output from each of the switches, and includes a frame buffer to temporarily store the frames output from each of the switches.

11. A control method of a frame transfer device including switches that are a power saving switch and a high performance switch, the high performance switch consuming more power and being capable of higher performance than the power saving switch, the control method comprising:
activating one of the switches of the power saving switch and the high performance switch and deactivating the other one of the switches depending on a network load;
allocating a received frame to the one of the switches that has been activated; and
calculating a predicted load, which is a network load after a reference time period, and comparing the predicted load with a threshold to determine which one of the switches of the power saving switch and the high performance switch is to be activated, and when the power saving switch has been activated, activating the high performance switch and deactivating the power saving switch when the predicted load exceeds a first threshold.

12. A control method of a frame transfer device including switches that are a power saving switch and a high performance switch, the high performance switch consuming more power and being capable of higher performance than the power saving switch, the control method comprising:
activating one of the switches of the power saving switch and the high performance switch and deactivating the other one of the switches depending on a network load;
allocating a received frame to the one of the switches that has been activated; and
calculating a predicted load, which is a network load after a reference time period, and comparing the predicted load with a threshold to determine which one of the switches of the power saving switch and the high performance switch is to be activated, and when the high performance switch has been activated, activating the power saving switch and deactivating the high performance switch when the predicted load becomes lower than a second threshold.

13. A control method of a frame transfer device including switches that are a power saving switch and a high performance switch, the high performance switch consuming more power and being capable of higher performance than the power saving switch, the control method comprising:
activating one of the switches of the power saving switch and the high performance switch and deactivating the other one of the switches depending on a network load;
allocating a received frame to the one of the switches that has been activated;
multiplexing frames output from each of the switches; and
permitting, after activating the one of the switches, a frame to be output from the one of the switches when there is no longer any frame being output from the other one of the switches.

14. A non-transitory computer readable medium storing a control program to control a frame transfer device including switches that are a power saving switch and a high performance switch, the high performance switch consuming more power and being capable of higher performance than the power saving switch, the control program causing a computer to execute:
a control process of activating one of the switches of the power saving switch and the high performance switch and deactivating the other one of the switches depending on a network load; and
an allocation process of allocating a received frame to the one of the switches activated by the control process,
wherein the control process calculates a predicted load, which is a network load after a reference time period, and compares the predicted load with a threshold to determine which one of the switches of the power saving switch and the high performance switch is to be activated, and when the power saving switch has been activated, the control process activates the high performance switch and deactivates the power saving switch when the predicted load exceeds the first threshold.

15. A non-transitory computer readable medium storing a control program to control a frame transfer device including switches that are a power saving switch and a high performance switch, the high performance switch consuming more power and being capable of higher performance than the power saving switch, the control program causing a computer to execute:
a control process of activating one of the switches of the power saving switch and the high performance switch and deactivating the other one of the switches depending on a network load; and
an allocation process of allocating a received frame to the one of the switches activated by the control process,
wherein the control process calculates a predicted load, which is a network load after a reference time period, and compares the predicted load with a threshold to determine which one of the switches of the power saving switch and the high performance switch is to be activated, and when the high performance switch has been activated, the control process activates the power saving switch and deactivates the high performance switch when the predicted load becomes lower than a second threshold.

16. A non-transitory computer readable medium storing a control program to control a frame transfer device including switches that are a power saving switch and a high performance switch, the high performance switch consuming more power and being capable of higher performance than the power saving switch, the control program causing a computer to execute:
a control process of activating one of the switches of the power saving switch and the high performance switch and deactivating the other one of the switches depending on a network load;
an allocation process of allocating a received frame to the one of the switches activated by the control process; and
a multiplexing process of multiplexing frames output from each of the switches,
wherein after activating the one of the switches, the control process permits a frame to be output from the one of the switches when there is no longer any frame being output from the other one of the switches.
